(19) United States
(12) Patent Application Publication
(10) Pub. No.: US 2014/0119403 A1
(43) Pub. Date: May 1, 2014

(54) APPARATUS AND METHOD FOR MEASURING TEMPERATURE

(71) Applicant: SAMSUNG ELECTRO-MECHANICS CO., LTD., Suwon (KR)

(72) Inventor: Yo Sub MOON, Gyunggi-do (KR)

(73) Assignee: SAMSUNG ELECTRO-MECHANICS CO., LTD., Suwon (KR)

(21) Appl. No.: 13/759,555

(22) Filed: Feb. 5, 2013

(30) Foreign Application Priority Data
Oct. 31, 2012 (KR) 10-2012-0122614

(51) Int. Cl. G01K 11/26

(52) U.S. Cl. CPC G01K 11/26
USPC 374/117

(57) ABSTRACT

There are provided an apparatus and a method for measuring a temperature. The apparatus includes: a temperature sensor measuring a temperature and providing the measured temperature; a temperature comparing unit comparing the measured temperature with a preset reference temperature and providing a comparison result signal; a quartz oscillating unit generating an oscillating frequency signal according to temperature; a frequency counting unit counting a frequency of the oscillating frequency signal and providing a frequency count value; and a signal processing unit determining a temperature according to the comparison result signal and the frequency count value.

### CROSS-REFERENCE TO RELATED APPLICATIONS

This application claims the priority of Korean Patent Application No. 10-2012-0122614 filed on Oct. 31, 2012, in the Korean Intellectual Property Office, the disclosure of which is incorporated herein by reference.

### BACKGROUND OF THE INVENTION

1. Field of the Invention

The present invention relates to an apparatus and a method for measuring a temperature capable of being applied to a system on chip (SoC) and accurately measuring a temperature thereof using a temperature sensor and a quartz vibrator.

2. Description of the Related Art

A system on chip (SoC), in which a plurality of integrated chips (ICs) are incorporated in a single unit, is commonly used in order to decrease cost and conserve space in various industrial fields.

In addition, due to the ever increasing use of commercially-available power in industrial, domestic and commercial settings, demand for a smart power meter has gradually increased to allow for a more economical and efficient means of power measurement.

Moreover, a system on chip (SoC) electronic watt-hour meter has also been manufactured, processing data using a single IC. Both current and voltage need to be accurately measured due to characteristics of the electronic watt-hour meter. To this end, initial calibration is required for each IC to reduce deviations in measurement. Further, since characteristics of the IC or an external part may be changed according to ambient temperature, calibration is necessarily performed according to changes in temperature.

An apparatus for measuring a temperature in an existing system on chip (SoC) may include a temperature sensor, an analog digital converter (A/D converter), and a digital signal processor (DSP).

The temperature sensor outputs a signal corresponding to temperature. The A/D converter converts the signal from the temperature sensor into a digital signal. The digital signal processor (DSP) performs a predetermined signal processing process on the digital signal from the A/D converter.

Here, the temperature sensor may output a signal having a voltage difference of 8 mV per 1° C. Here, the signal having a magnitude of 8 mV is a significantly small signal which may be influenced by noise in a peripheral circuit. For example, in the case in which the output signal of the temperature sensor is influenced by the noise, resolution of the temperature sensor may be degraded, whereby it is difficult to accurately measure an amount of heat generated in the IC.

Moreover, since separate A/D converters are required to measure the temperature, size and current consumption of the IC are also increased.

Patent Document 1, described in the following related art document, related to an apparatus for measuring a temperature change, fails to disclose measuring temperature using a temperature sensor and a quartz vibrator.

### RELATED ART DOCUMENT

(Patent Document 1) Korean Patent Laid-Open Publication No. 10-2011-0071675

### SUMMARY OF THE INVENTION

An aspect of the present invention provides an apparatus and a method for measuring a temperature capable of accurately measuring a temperature using a temperature sensor and a quartz vibrator.

According to an aspect of the present invention, there is provided an apparatus for measuring a temperature, the apparatus including: a temperature sensor measuring a temperature and providing the measured temperature; a temperature comparing unit comparing the measured temperature with a preset reference temperature and providing a comparison result signal; a quartz oscillating unit generating an oscillating frequency signal according to temperature; a frequency counting unit counting a frequency of the oscillating frequency signal and providing a frequency count value; and a signal processing unit determining a temperature according to the comparison result signal and the frequency count value.

The temperature comparing unit may provide a comparison result signal having a first logic level when the measured temperature is equal to or higher than the reference temperature, and provide a comparison result signal having a second logic level different from the first logic level when the measured temperature is lower than the reference temperature.

The quartz oscillating unit may include: a quartz vibrator generating a resonance frequency signal according to the temperature; and an oscillator oscillating the resonance frequency signal and generating the oscillating frequency signal.

The quartz oscillating unit may further include a buffer outputting the oscillating frequency signal from the oscillator.

The frequency counting unit may include: a signal converter converting the oscillating frequency signal from the quartz oscillating unit into a square wave signal; and a counter counting the square wave signal from the signal converter using a preset reference clock and providing the frequency count value to the signal processing unit.

The signal processing unit may select one of a first search region and a second search region in a preset temperature range according to the comparison result signal and may determine a temperature corresponding to the frequency count value from the frequency counting unit in the selected search region.

The signal processing unit may include: a memory dividing a preset temperature range into a first search region and a second search region and storing the frequency count value and the temperature in a state of matching the frequency count value and the temperature to each other in each of the first search region and the second search region; and a microcontroller selecting one of the first search region and the second search region of the memory according to the comparison result signal and determining a temperature corresponding to the frequency count value in the selected search region.

According to another aspect of the present invention, there is provided a method of measuring a temperature performed by an apparatus for measuring a temperature, the method including: measuring a temperature using a temperature sensor and providing the measured temperature; comparing the measured temperature with a preset reference temperature and providing a comparison result signal; generating an oscillating frequency signal according to temperature using a quartz vibrator; counting a frequency of the oscillating frequency signal and providing a frequency count value; and determining a temperature according to the comparison result signal and the frequency count value.

The providing of the comparison result signal may include: providing a comparison result signal having a first logic level when the measured temperature is equal to or higher than the reference temperature; and providing a comparison result signal having a second logic level different from the first logic level when the measured temperature is lower than the reference temperature.

The generating of the oscillating frequency signal may include: generating a resonance frequency signal according to the temperature using the quartz vibrator; and oscillating the resonance frequency signal and generating the oscillating frequency signal.

The providing of the frequency count value may include: converting the oscillating frequency signal into a square wave signal; and counting the square wave signal using a preset reference clock and providing the frequency count value.

The determining of the temperature may include: selecting one of a first search region and a second search region in a preset temperature range according to the comparison result signal; and determining a temperature corresponding to the frequency count value in the selected search region.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating an apparatus for measuring a temperature according to an embodiment of the present invention;

FIG. 2 is a temperature-frequency characteristics graph of a quartz vibrator according to an embodiment of the present invention;

FIG. 3 is a block diagram illustrating a frequency counting unit according to an embodiment of the present invention;

FIG. 4 is a view describing a counting operation of a counter according to an embodiment of the present invention;

FIG. 5 is a block diagram illustrating a signal processing unit according to an embodiment of the present invention;

FIG. 6 is a view illustrating a look-up table of a memory according to an embodiment of the present invention;

FIG. 7 is a flowchart illustrating a method of measuring a temperature according to an embodiment of the present invention;

FIG. 8 is a flowchart illustrating a process for generating an oscillating frequency signal according to an embodiment of the present invention; and

FIG. 9 is a flowchart illustrating a process for generating a frequency count value according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like elements.

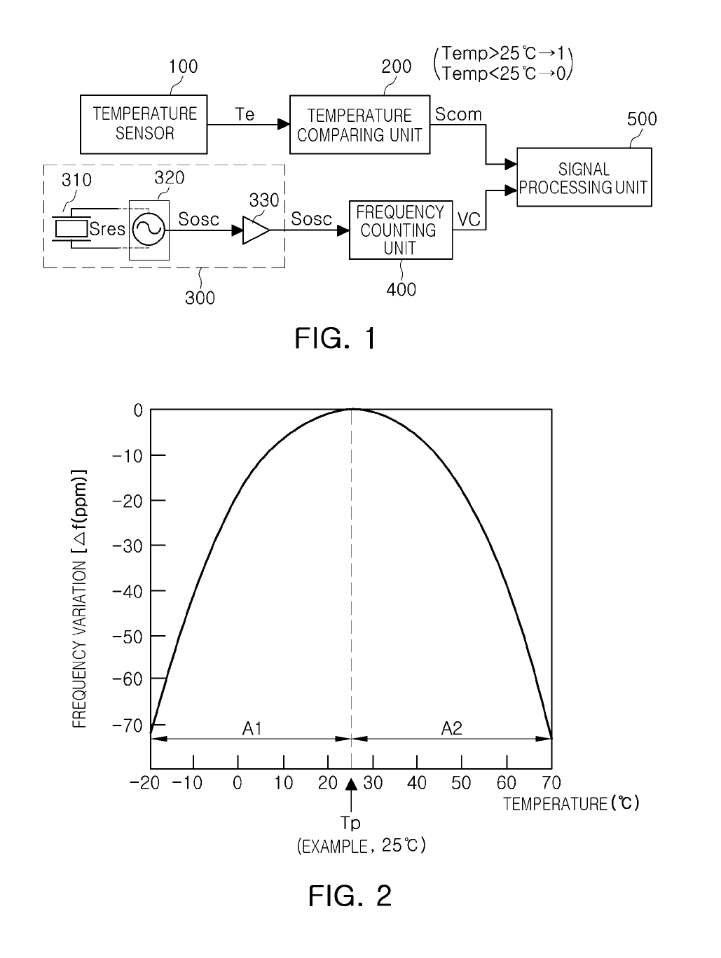

FIG. 1 is a block diagram illustrating an apparatus for measuring a temperature according to an embodiment of the present invention.

Referring to FIG. 1, an apparatus for measuring a temperature according to an embodiment of the present invention may include a temperature sensor 100, a temperature comparing unit 200, a quartz oscillating unit 300, a frequency counting unit 400, and a signal processing unit 500.

The temperature sensor 100 may measure an actual temperature of a system to which the apparatus for measuring the temperature according to the embodiment of the present invention is applied and provide the measured temperature Te. The temperature sensor 100 may provide the measured temperature Te in proportion to the actual temperature to the temperature comparing unit 200. For example, as the actual temperature increases, the measured temperature Te may increase.

The temperature comparing unit 200 may compare the measured temperature Te with a preset reference temperature Tref and provide a comparison result signal Scom to the signal processing unit 500.

The temperature comparing unit 200 may provide a comparison result signal Scom having a first logic level in the case in which the measured temperature Te is equal to or higher than the reference temperature Tref, and may provide a comparison result signal Scom having a second logic level different from the first logic level in the case in which the measured temperature is lower than the reference temperature Tref.

Here, the first and second logic levels may be determined according to the system, and the first and second logic levels may become a high level (logic 1) and a low level (logic 0), or a low level and a high level, respectively.

The quartz oscillating unit 300 may generate an oscillating frequency signal Sosc according to temperature and provide the oscillating frequency signal Sosc to the frequency counting unit 400.

As an example, the quartz oscillating unit 300 may include a quartz vibrator 301 and an oscillator 320. As another example, the quartz oscillating unit 300 may include the quartz vibrator 301, the oscillator 320, and a buffer 330.

The quartz vibrator 310 may generate a resonance frequency signal Sres according to temperature and provide the resonance frequency signal Sres to the oscillator 320. The oscillator 320 may oscillate the resonance frequency signal Sres to thereby generate the oscillating frequency signal Sosc and provide the oscillating frequency signal Sosc to the buffer 330 or the frequency counting unit 400.

In addition, in the case in which the quartz oscillating unit 300 includes the buffer 330, the buffer 330 may provide the oscillating frequency signal Sosc from the oscillator 320 to the frequency counting unit 400.

The frequency counting unit 400 may count frequency of the oscillating frequency signal Sosc and provide a frequency count value VC to the signal processing unit 500.

In addition, the signal processing unit 500 may determine temperature according to the comparison result signal Scorn from the temperature comparing unit 200 and the frequency count value VC from the frequency counting unit 400.

FIG. 2 is a temperature-frequency characteristics graph of a quartz vibrator according to an embodiment of the present invention.

The quartz vibrator 310 may generate the measured temperature Te which is an analog signal containing temperature characteristics data, as shown in FIG. 2.

Here, the temperature-frequency characteristics of the quartz vibrator 310 are different based on a specific temperature Tp (25° C. for example). For example, assuming that a specific temperature Tp is 25° C., the temperature-frequency characteristics of the quartz vibrator 310 are characterized in that in a first region A1 of 25° C. or lower, the higher the temperature is, the higher the frequency is; and in a second region A2 of 25° C. or higher, the higher the temperature is, the lower the frequency is. According to the above-mentioned characteristics, it may be appreciated that a temperature corresponding to one frequency count value VC exists in each of the first and second regions A1 and A2, that is, two temperatures exist.

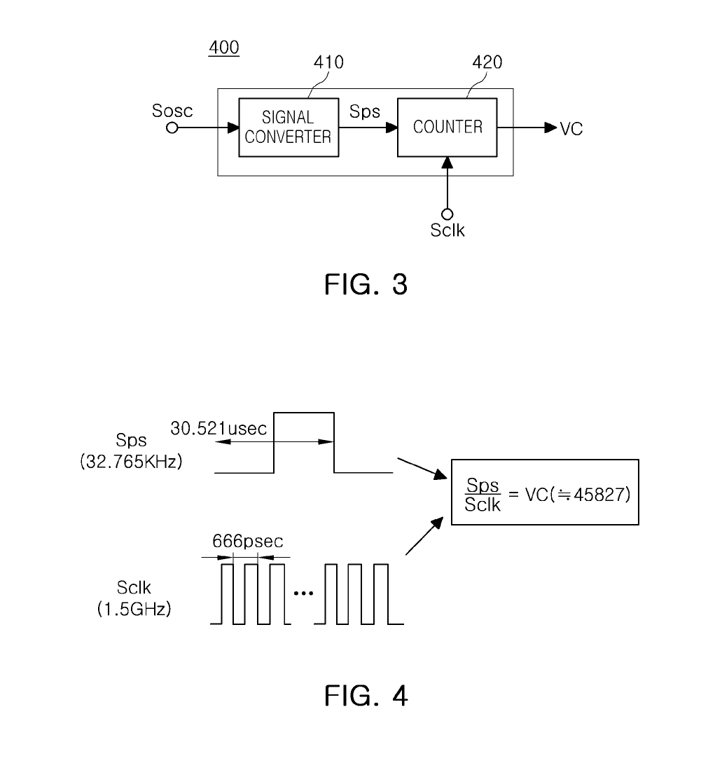

FIG. 3 is a block diagram illustrating a frequency counting unit according to an embodiment of the present invention.

Referring to FIG. 3, the frequency counting unit 400 may include a signal converter 410 and a counter 420.

The signal converter 410 may convert the oscillating frequency signal Sosc from the quartz oscillating unit 300 into a square wave signal Sps.

The counter 420 may count the square wave signal Sps from the signal converter 410 using a preset reference clock Sclk and provide the frequency count value VC to the signal processing unit 500.

FIG. 4 is a view describing a counting operation of a counter according to an embodiment of the present invention.

Referring to FIG. 4, in the case in which the frequency of the quartz vibrator 310 is 32.768 KHz (period=30.517 μsec) at 25° C. and the frequency of the reference clock Sclk is 1.5 GHz (period=666 psec), assuming that the frequency of the square wave signal Sps is 32.765 KHz (period=30.521 μsec) when an actual temperature in which the apparatus for measuring temperature according to the embodiment of the present invention is used is 10° C., if the frequency of the square wave signal Sps (32.765 KHz, period=30.521 μsec) is counted by the reference clock Sclk (1.5 GHz, period=666 psec), the frequency count value VC may become 45827.

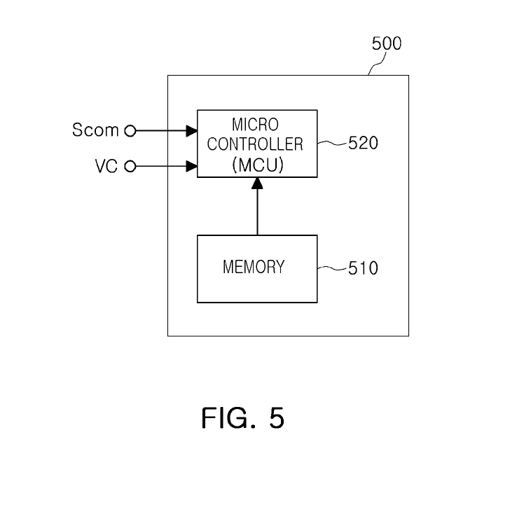

FIG. 5 is a block diagram illustrating a signal processing unit according to an embodiment of the present invention.

Referring to FIG. 5, the signal processing unit 500 may select one of first and second search regions SA1 and SA2 in a preset temperature range according to the comparison result signal Scom from the temperature comparing unit 200 and may determine the temperature corresponding to the frequency count value VC from the frequency counting unit 400 in the selected search region. For example, in the case in which the temperature Te measured by the temperature sensor 100 is 25° C. or less, the first search region SA1 will be selected.

As an example, the signal processing unit 500 may include a memory 510 and a microcontroller (MCU) 520.

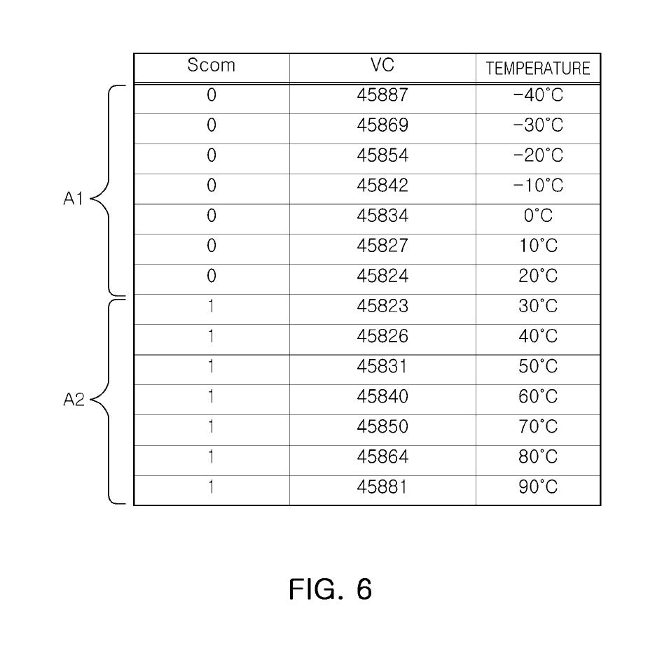

FIG. 6 is a view illustrating a look-up table of a memory according to an embodiment of the present invention.

Referring to FIGS. 5 and 6, the memory 510 may divide the preset temperature range into the first and second search regions SA1 and SA2 and may store the frequency count value and the temperature in the state of matching the frequency count value and the temperature to each other in each of the first and second search regions SA1 and SA2.

For example, the memory 510 may include a lookup table as shown in FIG. 6. The lookup table includes temperatures which are pre-matched to respective frequency count values VC, for the first and second search regions SA1 and SA2.

The microcontroller (MCU) 520 may select one of the first and second search regions SA1 and SA2 of the memory 510 according to the comparison result signal Scom from the temperature comparing unit 200 and may determine the temperature corresponding to the frequency count value VC in the selected search region.

For example, in the case in which the temperature Te measured by the temperature sensor 100 is 25° C. or less, when the frequency count value VC is 45827, the microcontroller (MCU) 520 may determine 10° C., corresponding to the frequency count value VC (45827) in the first search region SA1 of the memory 510.

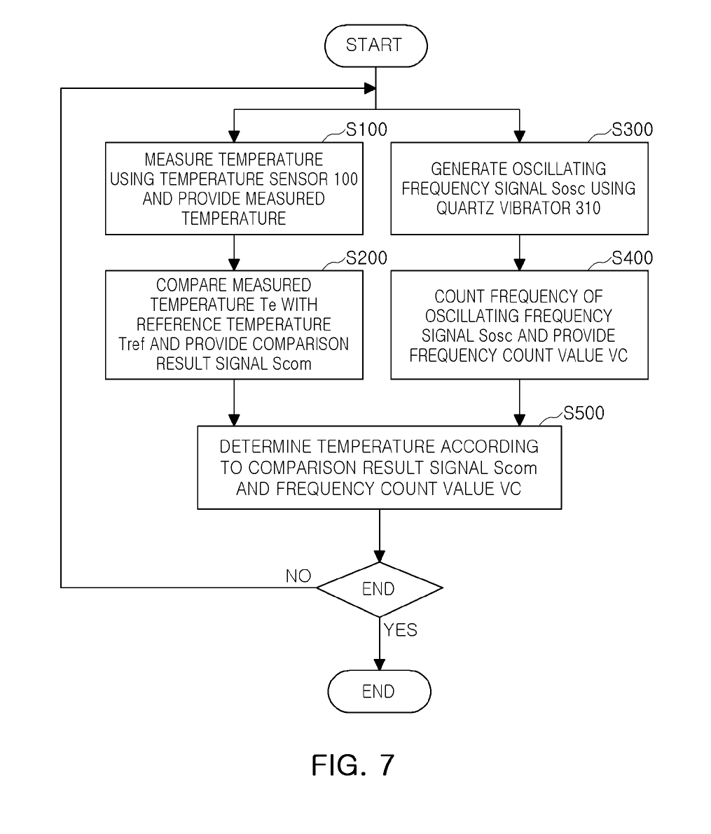

FIG. 7 is a flowchart illustrating a method of measuring a temperature according to an embodiment of the present invention.

Referring to FIGS. 1 through 7, the method of measuring a temperature according to the embodiment of the present invention may be performed by the apparatus for measuring a temperature in the following manner.

In addition, the detailed description provided above with reference to FIGS. 1 through 6 may also be applied to the method of measuring a temperature and an overlapped description may be omitted.

In the method of measuring a temperature according to the embodiment of the present invention, the temperature sensor 100 may measure an actual temperature of the system in which the apparatus for measuring a temperature according to the embodiment of the present invention is adopted and may provide the measured temperature Te to the temperature comparing unit 200 (S100).

The temperature comparing unit 200 may compare the measured temperature Te with a preset reference temperature Tref and may provide a comparison result signal Scom to the signal processing unit 500 (S200).

For example, the temperature comparing unit 200 may provide a comparison result signal Scom having a first logic level in the case in which the measured temperature Te is equal to or higher than the reference temperature Tref, and may provide a comparison result signal Scom having a second logic level different from the first logic level in the case in which the measured temperature Te is lower than the reference temperature Tref.

Meanwhile, the quartz oscillating unit 300 may generate an oscillating frequency signal Sosc according to temperature using the quartz vibrator 310 and may provide the oscillating frequency signal Sosc to the frequency counting unit 400 (S300).

In addition, the frequency counting unit 400 may count the frequency of the oscillating frequency signal Sosc and may provide a frequency count value VC to the signal processing unit 500 (S400).

The signal processing unit 500 may determine the temperature according to the comparison result signal Scom and the frequency count value VC (S500).

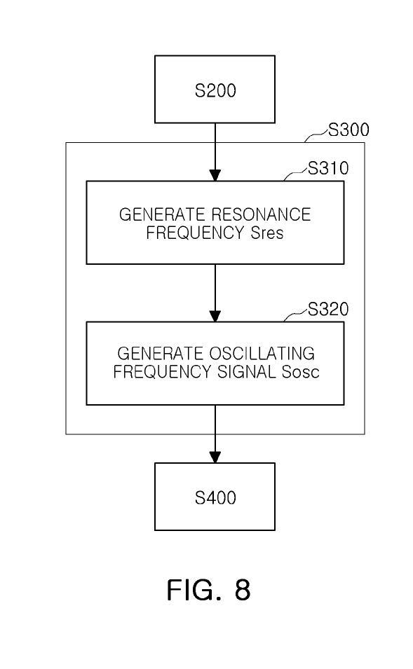

FIG. 8 is a flowchart illustrating a process for generating an oscillating frequency signal according to an embodiment of the present invention.

Referring to FIGS. 1 through 8, the quartz oscillating unit 300 may generate a resonance frequency signal Sres according to temperature using the quartz vibrator 310 (S310). In addition, the quartz oscillating unit 300 may oscillate the resonance frequency signal Sres and may generate an oscillating frequency signal Sosc (S320).

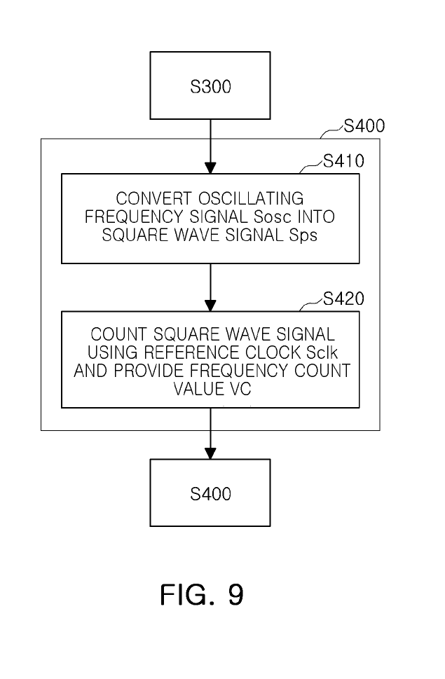

FIG. 9 is a flowchart illustrating a process for generating a frequency count value according to an embodiment of the present invention.

Referring to FIGS. 1 through 9, the frequency counting unit 400 may convert the oscillating frequency signal Sosc into a square wave signal Sps (S410). In addition, the frequency counting unit 400 may count the square wave signal Sps using a preset reference clock Sclk and may provide a frequency count value VC to the signal processing unit 500 (S420).

In addition, the signal processing unit 500 may select one of the first and second regions SA1 and SA2 in a preset temperature range according to the comparison result signal Scom and may determine the temperature corresponding to the frequency count value VC in the selected search region (S500).

As set forth above, according to embodiments of the present invention, there may be provided an apparatus and a method for measuring a temperature capable of being applied to a system on chip (SoC) and accurately measuring temperature using a temperature sensor and a quartz vibrator.

While the present invention has been shown and described in connection with the embodiments, it will be apparent to those skilled in the art that modifications and variations can be made without departing from the spirit and scope of the invention as defined by the appended claims.

What is claimed is:

1. An apparatus for measuring a temperature, the apparatus comprising:
a temperature sensor measuring a temperature and providing the measured temperature;
a temperature comparing unit comparing the measured temperature with a preset reference temperature and providing a comparison result signal;
a quartz oscillating unit generating an oscillating frequency signal according to temperature;
a frequency counting unit counting a frequency of the oscillating frequency signal and providing a frequency count value; and
a signal processing unit determining a temperature according to the comparison result signal and the frequency count value.

2. The apparatus of claim 1, wherein the temperature comparing unit provides a comparison result signal having a first logic level when the measured temperature is equal to or higher than the reference temperature, and provides a comparison result signal having a second logic level different from the first logic level when the measured temperature is lower than the reference temperature.

3. The apparatus of claim 1, wherein the quartz oscillating unit includes:
a quartz vibrator generating a resonance frequency signal according to the temperature; and
an oscillator oscillating the resonance frequency signal and generating the oscillating frequency signal.

4. The apparatus of claim 3, wherein the quartz oscillating unit further includes a buffer outputting the oscillating frequency signal from the oscillator.

5. The apparatus of claim 1, wherein the frequency counting unit includes:
a signal converter converting the oscillating frequency signal from the quartz oscillating unit into a square wave signal; and
a counter counting the square wave signal from the signal converter using a preset reference clock and providing the frequency count value to the signal processing unit.

6. The apparatus of claim 1, wherein the signal processing unit selects one of a first search region and a second search region in a preset temperature range according to the comparison result signal and determines a temperature corresponding to the frequency count value from the frequency counting unit in the selected search region.

7. The apparatus of claim 1, wherein the signal processing unit includes:
a memory dividing a preset temperature range into a first search region and a second search region and storing the frequency count value and the temperature in a state of matching the frequency count value and the temperature to each other in each of the first search region and the second search region; and
a microcontroller selecting one of the first search region and the second search region of the memory according to the comparison result signal and determining a temperature corresponding to the frequency count value in the selected search region.

8. A method of measuring a temperature performed by an apparatus for measuring a temperature, the method comprising:
measuring a temperature using a temperature sensor and providing the measured temperature;
comparing the measured temperature with a preset reference temperature and providing a comparison result signal;
generating an oscillating frequency signal according to temperature using a quartz vibrator;
counting a frequency of the oscillating frequency signal and providing a frequency count value; and
determining a temperature according to the comparison result signal and the frequency count value.

9. The method of claim 8, wherein the providing of the comparison result signal includes:
providing a comparison result signal having a first logic level when the measured temperature is equal to or higher than the reference temperature; and
providing a comparison result signal having a second logic level different from the first logic level when the measured temperature is lower than the reference temperature.

10. The method of claim 8, wherein the generating of the oscillating frequency signal includes:
generating a resonance frequency signal according to the temperature using the quartz vibrator; and
oscillating the resonance frequency signal and generating the oscillating frequency signal.

11. The method of claim 8, wherein the providing of the frequency count value includes:
converting the oscillating frequency signal into a square wave signal; and
counting the square wave signal using a preset reference clock and providing the frequency count value.

12. The method of claim 8, wherein the determining of the temperature includes:
selecting one of a first search region and a second search region in a preset temperature range according to the comparison result signal; and
determining a temperature corresponding to the frequency count value in the selected search region.
